(19) United States
(12) Patent Application Publication
(10) Pub. No.: US 2012/0314448 A1
(43) Pub. Date: Dec. 13, 2012

(54) Vehicular Lamp

(75) Inventor: Asami Nakada, Shizuoka-shi (JP)

(73) Assignee: Koito Manufacturing Co., Ltd., Tokyo (JP)

(21) Appl. No.: 13/488,899

(22) Filed: Jun. 5, 2012

(30) Foreign Application Priority Data
Jun. 7, 2011 (JP) 2011-127592

(51) Int. Cl. B60Q 1/00

(52) U.S. Cl. 362/602

(57) ABSTRACT

A vehicular lamp including a light guide in which light emitted from a light-emitting diode (30) is incident into a relatively short light guide (20), which extends in a horizontal direction intersecting the front-back direction of the lamp, from a left end surface (20a) and thereafter totally reflected by a plurality of reflective elements (20s) provided in the rear surface portion (20c) and then emitted out from the front surface portion (20d) toward the front of the lamp. A first incident portion (20a1) is provided in an intermediate region, in the front-back direction, of the left end surface (20a) of the light guide (20) so as to cause the light emitted from the light-emitting diode (30) to be incident into the light guide (20) while being refracted toward the rear of the lamp.

### BACKGROUND OF THE INVENTION

1. Field of the Invention

The present invention relates to a vehicular lamp including a light guide.

2. Background Art

In one type of known vehicular lamp, light emitted from a light source such as a light-emitting diode is incident into a light guide from one end surface threof and thereafter internally reflected by a plurality of reflective elements formed in the rear surface portion of the light guide and then emitted out from the front surface portion of the light guide toward the front of the vehiclur lamp.

Japanese Patent Application Laid-Open (Kokai) No. 2002-367404 discloses such a vehicular lamp as described above, and in this vehicular lamp, the light guide is formed to extend along a direction that intersects the front-back direction of the lamp.

In the vehicular lamp that includes the light guide as described above, if the light guide is relatively short, part of the light emitted from the light source to be incident from one end surface of the light guide may directly reach the other end surface, and as a result, the light from the light source may not be effectively utilized as light radiated from the lamp.

### SUMMARY OF THE INVENTION

The present invention has been made in view of the foregoing circumstances, and it is, therefore, an object of the present invention to provide a vehicular lamp that includes a light guide and allows light from a light source to be effectively utilized even in the case that the light guide is relatively short.

The present invention aims to achieve the foregoing object by devising the shape of the light guide.

More specifically, the present invention provides a vehicular lamp that includes a light source and a light guide configured such that the light emitted from the light source is incident into the light guide from one end surface (or a first end surface) of the light guide and thereafter internally reflected by a plurality of reflective elements provided in a rear surface portion of the light guide and then emitted out from the front surface portion of the light guide toward the front of the lamp, and the vehicular lamp of the present invention is characterized in that:
the light guide extends along a first direction that intersects a front-back direction of the lamp, and
a first incident portion is provided in an intermediate region, in the front-back direction, of the one (first) end surface of the light guide so as to cause the light emitted from the light source to be incident into the light guide while being refracted in a direction away from the first direction with respect to the front-back direction of the lamp.

In the above and following descriptions, the type of the “light source” is not specifically limited, and, for example, a light-emitting diode can be adopted as the light source.

The shape of the “light guide” is not specifically limited as long as the light guide extends along the first direction that intersects the front-back direction of the lamp.

The “first direction” may be any of a horizontal direction, a vertical direction, and an oblique direction, and this “first direction” can be a direction defined by a straight line or a direction defined by a curved line as long as the first direction intersects the front-back direction of the lamp.

The cross-sectional shape of the “reflective elements” is not specifically limited as long as the reflective elements are configured to internally reflect the light from the light source reaching the elements. The “internal reflection” caused by the reflective elements can be a total reflection, or an ordinary mirror reflection caused by mirror finishing made on the surfaces of the reflective elements.

The shape of the “first incident portion” is not specifically limited as long as the first incident portion is provided in an intermediate region, in the front-back direction, of the one (first) end surface of the light guide so as to cause the light emitted from the light source to be incident into the light guide while being refracted in a direction away from the first direction with respect to the front-back direction of the lamp.

As described above, in the vehicular lamp according to the present invention, light emitted from the light source is incident into the light guide from the one (first) end surface of the light guide and thereafter internally reflected by the plurality of reflective elements provided in the rear surface portion of the light guide and then emitted out from the front surface portion of the light guide toward the front of the lamp, the light guide extends along the first direction that intersects the front-back direction of the lamp, and the first incident portion is provided in an intermediate region, in the front-back direction, of the one (first) end surface of the light guide so as to cause the light emitted from the light source to be incident into the light guide while being refracted in a direction away from the first direction (or opposite from the first direction) in the front-back direction of the lamp. Accordingly, the following effects, among others, can be obtained.

In the vehicular lamp according to the present invention, the first incident portion is provided in an intermediate region, in the front-back direction, of the one (first) end surface of the light guide so as to cause the light emitted from the light source to be incident into the light guide while being refracted in a direction away from (or opposite to) the first direction with respect to the front-back direction of the lamp. Accordingly, part of the light from the light source to be incident into the light guide from the one (first) end surface is effectively prevented from reaching the other end surface (or the second end surface), either directly or after being internally reflected by the rear surface portion or the front surface portion even if the light guide is relatively short. As a result, the light from the light source is effectively utilized as light radiated from the lamp.

According to the present invention, it is, therefore, possible to provide a vehicular lamp that includes a light guide in which light emitted from the light source is effectively utilized as light radiated from the lamp even in the case that the light guide is relatively short.

In the configuration described above, a second incident portion can be provided in the intermediate region, in the front-back direction, of the one (first) end surface of the light guide at a position adjacent to the first incident portion in the front-back direction so as to cause the light emitted from the light source to be incident into the light guide while being refracted in a direction opposite to the direction of the refraction caused by the first incident portion. In this structure, the light from the light source to be incident from the intermediate region of the one (first) end surface can be divided into a portion to be refracted forward and a portion to be refracted rearward, and this makes it possible to more effectively prevent light that is incident from the intermediate region of the one (first) end surface from directly reaching the other (second) end surface.

In the configuration described above, the first incident portion can be provided as a cylindrical lens that causes the light emitted from the light source to be incident as light that is substantially parallel with a plane that includes the front-back direction of the lamp and the first direction. In this structure, light incident from the intermediate region of the one (first) end surface can efficiently reach the plurality of reflective elements provided in the rear surface portion and is effectively utilized as light radiated from the lamp.

In the configuration described above, a third incident portion can be provided in front of the intermediate region of the one (first) end surface of the light guide so as to cause the light emitted from the light source to be incident into the light guide while being refracted toward the rear of the lamp. In this structure, most of the light that is incident from the third incident portion can be totally reflected by the front surface portion of the light guide and effectively utilized as light radiated from the lamp.

In the configuration described above, a fourth incident portion can be provided in the rear of the intermediate region of the one (first) end surface of the light guide so as to cause the light emitted from the light source to be incident into the light guide while being refracted toward the front of the lamp. In this structure, most of the light that is incident from the fourth incident portion can be totally reflected by the rear surface portion of the light guide and effectively utilized as light radiated from the lamp.

In the configuration described above, a reflector can be disposed at the rear of (or behind) the light guide to cause light leaking from the light guide to be re-incident into the light guide. In this structure, even if the light that is incident from the one (first) end surface of the light guide leaks from the rear surface portion of the light guide, such light can be effectively utilized as light radiated from the lamp.

### BRIEF DESCRIPTION OF THE SEVERAL VIEWS OF THE DRAWINGS

FIG. 1 is a cross-sectional top view of a vehicular lamp according to an embodiment of the present invention.

FIG. 2 is a detailed (enlarged) view of the encircled part II in FIG. 1.

FIG. 3 is a cross-sectional view taken along the line in FIG. 2.

FIG. 4 is a view similar to FIG. 1 and shows a modification of the embodiment of FIG.

FIG. 5 is a view similar to FIG. 1 and shows a related art as a comparative example to the embodiment of the present invention.

### DETAILED DESCRIPTION OF THE INVENTION

Hereinafter, an embodiment of the present invention will be described in detail with reference to the accompanying drawings.

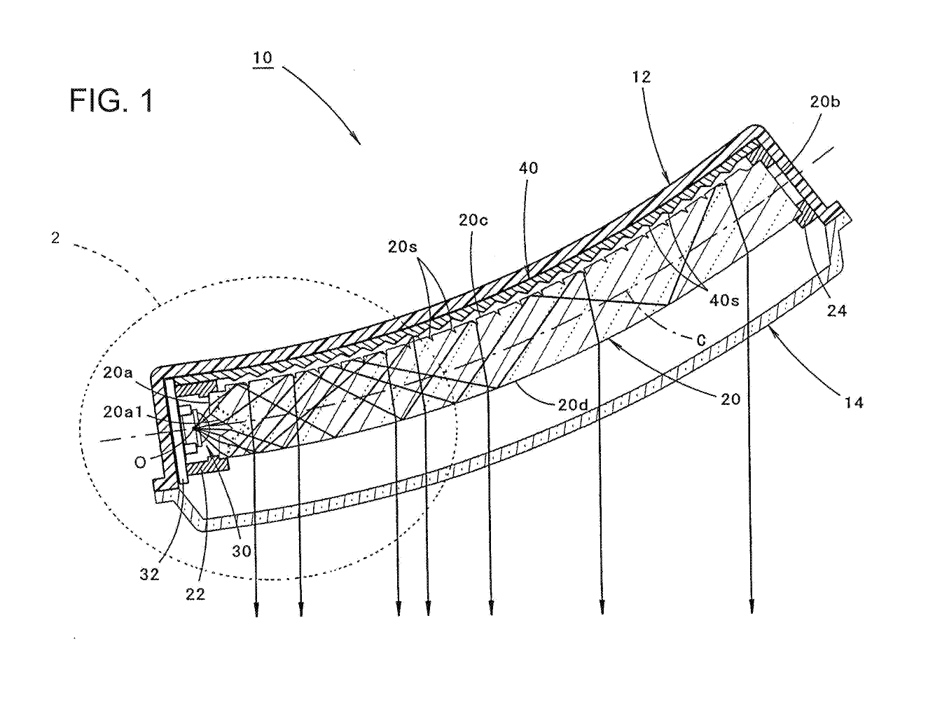

FIG. 1 is a cross-sectional top view of a vehicular lamp 10 according to the present embodiment.

As shown in FIG. 1, the vehicular lamp 10 is a tail lamp mounted on the right rear end portion of a vehicle, and it is constructed by incorporating a light guide 20 extending in a curved shape in the vehicle width direction and a light-emitting diode 30 disposed in the vicinity of the left end surface (first end surface) 20a of the light guide 20 in a lamp chamber formed by a lamp body 12 and a generally plain translucent cover 14 attached to the front end opening of the lamp body 12.

In the description of the shown embodiment, the terms indicating orientations in the front-back direction, such as “front” and “rear”, refer to the orientations of the vehicular lamp 10, which are opposite to the orientations of the vehicle.

The light guide 20 is formed to have a generally constant thickness and extends along a first direction that onttersects at substantially the right angles to the front-back direction of the lamp. More specifically, the light guide 20 is formed as a relatively short light guiding bar that extends along a curved line C bulging forward of the lamp 10, such that the left end surface 20a is located slightly frontward with respect to the right end surface (second end surface) 20b.

The translucent cover 14 is provided along a curved plane bulging forward. The curved line C extends in the horizontal direction generally along the curved shape of the translucent cover 14. The tangent to the curved line C at the left end surface 20a of the light guide 20 extends in a direction inclined rearward by about 10° Meanwhile, the tangent to the curved line C at the right end surface 20b of the light guide 20 extends in a direction inclined rearward by about 40°.

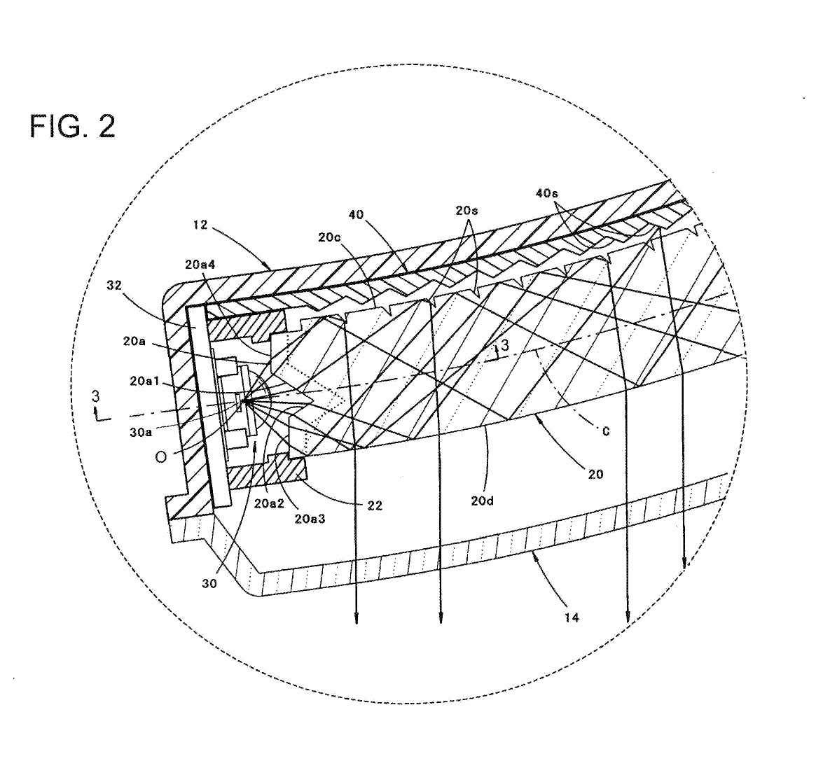

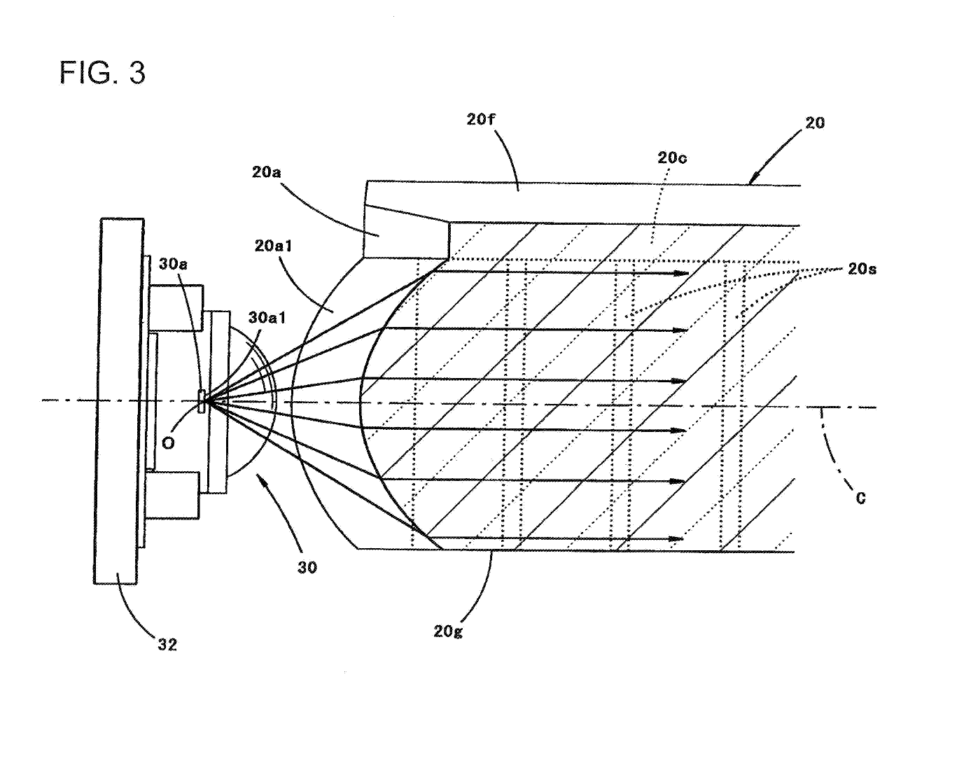

FIG. 2 is a detailed view of the part II in FIG. 1., and FIG. 3 is a cross-sectional view taken along the line in FIG. 2.

As also shown in FIG. 2 and FIG. 3, the cross-section of the light guide 20 taken along a plane orthogonal to the curved line C has a trapezoidal (or curved trapezoidal) shape. More specifically, the rear surface portion 20c and the front surface portion 20d of the light guide 20 are formed by vertical curved surfaces extending in parallel with each other with the curved line C substantially at the middle therebetween, the lower surface portion 20g of the light guide 20 is a horizontal surface, and the upper surface portion 20f of the light guide 20 is formed to be an inclined surface inclined upward toward the rear.

A plurality of reflective elements 20s are provided in the rear surface portion 20c of the light guide 20, other than the left and right end portions of the light guide 20, at generally equal intervals in the lateral direction. Each of the reflective elements 20s is provided as a total reflection prism in the shape of a V groove extending in the vertical direction over a range from the lower-end edge to the upper-end edge of the front surface portion 20d. The left inclined surface of each of the reflective elements 20s is, as best seen from FIG. 2, formed by a flat surface inclined by about 20 to 40° with respect to a plane orthogonal to the curved line C, and the right inclined surface of each of the reflective elements 20s is formed by a flat surface generally matching a plane orthogonal to the curved line C.

The light-emitting diode 30 is disposed with its light emission center O positioned on the curved line C and with the light-emitting surface 30a1 of its light-emitting chip 30a oriented in a direction inclined rearward by about 10°. The light-emitting diode 30 is fixedly supported by a light source supporting member 32. The light source supporting member 32 is fixedly supported by the lamp body 12.

The light guide 20 is fixedly supported by light guide supporting members 22 and 24 at its left and right end portions, respectively. The light guide supporting member 22 which supports the left end portion of the light guide 20 is fixedly supported by the light source supporting member 32 that has the light-emitting diode 30, and the light guide supporting member 24 which supports the right end portion of the light guide 20 is fixedly supported by the lamp body 12.

In the vehicular lamp 10 of the shown embodiment, light emitted from the light-emitting diode 30 is incident into the light guide 20 from the left end surface 20a and thereafter totally internally reflected by the plurality of reflective elements 20s provided at in the rear surface portion 20c and then emitted out from the front surface portion 20d toward the front of the lamp 10.

The right end surface (or the second end surface) 20b of the light guide 20 is formed by a surface that is orthogonal to the curved line C. The left end surface (or the first end surface) 20a of the light guide 20 is configured differently.

More specifically, a first incident portion 20a1 is provided in an intermediate region, in the front-back direction, of the left end surface 20a of the light guide 20 so as to cause the light emitted from the light-emitting diode 30 to be incident into the light guide 20 while being refracted toward the rear of the lamp. The first incident portion 20a1 extends in a direction inclined rightward by about 50 to 60° with respect to the forward direction of the lamp as viewed from above as seen from FIG. 2.

In addition, a second incident portion 20a2 is provided in the intermediate region, in the front-back direction, of the left end surface 20a of the light guide 20 so that it is at a position forwardly adjacent to the first incident portion 20a1 so as to cause the light emitted from the light-emitting diode 30 to be incident into the light guide 20 while being refracted toward the front of the lamp. The second incident portion 20a2 extends in a direction inclined leftward by about 50 to 60° with respect to the forward direction of the lamp as viewed from above as shown in FIG. 2.

Further, a third incident portion 20a3 is provided in the left end surface 20a of the light guide 20 in front of the second incident portion 20a2 so as to cause the light emitted from the light-emitting diode 30 to be incident into the light guide 20 while being refracted toward the rear of the lamp, and a fourth incident portion 20a4 is provided in the left end surface 20a of the light guide 20 at the rear of (or behind) the first incident portion 20a1 so as to cause the light emitted from the light-emitting diode 30 to be incident into the light guide 20 while being refracted toward the front of the lamp. Both the third and fourth incident portions 20a3 and 20a4 extend in substantially the same direction as the forward direction of the lamp as viewed from above as shown in FIG. 2.

The first to fourth incident portions 20a1 to 20a4 are each formed as a cylindrical lens that causes the light emitted from the light emission center O of the light-emitting diode 30 so as to be incident as light that is substantially parallel with a horizontal plane over a range from the lower end edge to the upper end edge of the front surface portion 20d.

A reflector 40 is disposed in the rear of the light guide 20 to cause light leaking from the light guide 20 to be re-incident into the light guide 20. The reflector 40 is disposed to extend along the rear surface portion 20c of the light guide 20, and fixedly supported by the lamp body 12. A plurality of reflective elements 40s are formed in a sawtooth shape on the front surface of the reflector 40 to extend in the vertical direction. These reflective elements 40s are provided at substantially the same pitch as that of the plurality of reflective elements 20s provided in the rear surface portion 20c of the light guide 20.

In the above-described vehicular lamp 10, the light emitted from the light-emitting diode 30 is incident into the light guide 20 from the left end surface (first end surface) 20a. Then, the light reaching the rear surface portion 20c of the light guide 20 is totally internally reflected by general portions (portions of the rear surface portion 20c where the reflective elements 20s are not provided) of the rear surface portion 20c, and thereafter totally internally reflected by the reflective elements 20s rightwardly adjacent to the general portions and then emitted out from the front surface portion 20d in substantially the forward direction of the lamp 10. In this event, the light internally reflected by the general portions of the rear surface portion 20c but not incident on the reflective elements 20s rightwardly adjacent to the general portions is totally internally reflected by the front surface portion 20d, so that it thereafter reaches the rear surface portion 20c again.

Meanwhile, the light internally reflected by the front surface portion 20d of the light guide 20 and thereafter directly reaches each of the reflective elements 20s (or the light that is incident from the left end surface 20a and thereafter directly reaches each of the reflective elements 20s) is not totally reflected by the reflective element 20s but leaks out from the reflective element 20s toward the rear of the light guide 20. However, since the reflector 40 is disposed in the rear of the light guide 20, the light is reflected toward the front by the reflective elements 40s and thereafter re-incident into the light guide 20 from the rear surface portion 20c of the light guide 20 and then emitted out from the front surface portion 20d in substantually the forward direction of the lamp 10.

Next, how the vehicular lamp of the shown embodiment of the present invention works will be described in detail below.

In the vehicular lamp 10 according to the shown embodiment, the light emitted from the light-emitting diode 30 (that is, a light source) is incident into the light guide 20 from the left end surface 20a (that is, the first end surface) of the light guide 20, and thereafter internally reflected by the plurality of reflective elements 20s provided in the rear surface portion 20c of the light guide 20 and then emitted out from the front surface portion 20d of the light guide 20 toward the front of the lamp; and in this structure, the light guide 20 is provided along the curved line C that extends along the horizontal direction intersecting the front-back direction of the lamp, and the first incident portion 20a1 is provided in an intermediate region, in the front-back direction, of the left end surface 20a of the light guide 20 so that the first incident portion 20a1 causes the light emitted from the light-emitting diode 30 to be incident into the light guide 20 while being refracted toward the rear of the lamp (that is, in a direction away from the curved line C in the front-back direction of the lamp). Accordingly, the vehicular lamp of the present invention provides the effects as described below.

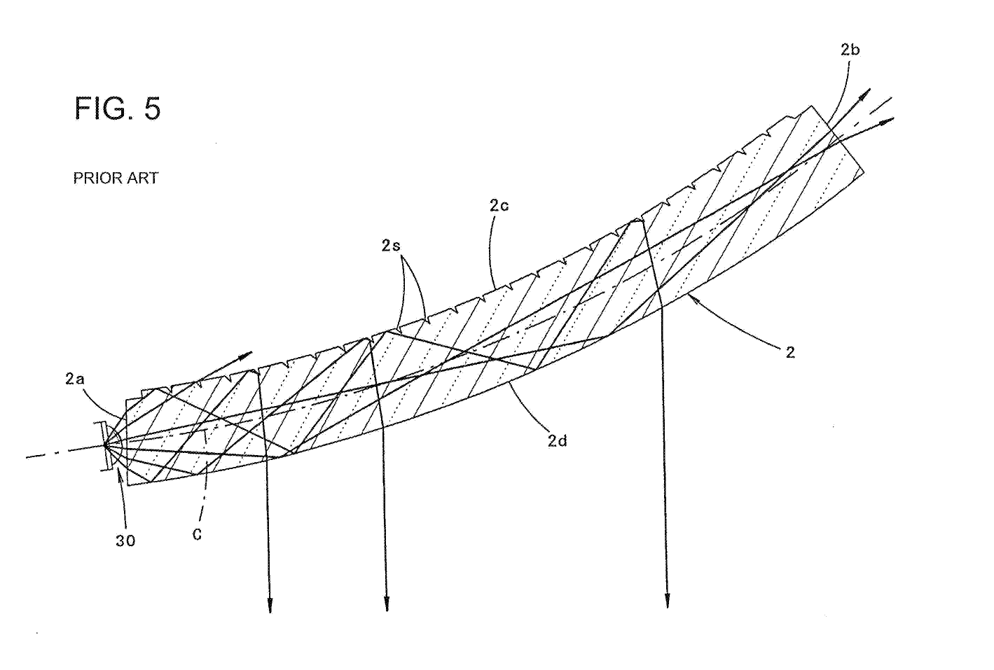

FIG. 5 is a view similar to FIG. 1 and shows an example according to the related art as a comparative example in order to illustrate the effects of the present embodiment.

As shown in FIG. 5, the light guide 2 of this related art is basically shaped in the same way as the light guide 20 of the shown embodiment of the present invention, and formed as a relatively short light guiding bar. However, the light guide 2 of the related art is different from the light guide 20 in the shape of the left end surface 2a.

In the light guide 2 of the related art, the left end surface 2a is a vertical surface extending in the front-back direction of the lamp.

When the light emitted from the light-emitting diode 30 is incident into the light guide 2 from the left end surface 2a of the light guide 2, the light that is incident at a relatively large angle, in the front-back direction, with respect to the direction along the curved line C is mostly internally reflected by the plurality of reflective elements 2s provided in the rear surface portion 2c of the light guide 2 and then emitted from the front surface portion 2d of the light guide 2 toward the front of the lamp, but the light that is incident at a relatively small angle, in the front-back direction, with respect to the direction along the curved line C may reach the right end surface 2b of the light guide 2, either directly or after being internally reflected by the rear surface portion 2c or the front surface portion 2d.

In this respect, in the vehicular lamp 10 of the shown embodiment, the first incident portion 20a1 is provided in an intermediate region, in the front-back direction, of the left end surface 20a of the light guide 20 so as to cause light emitted from the light-emitting diode 30 to be incident into the light guide 20 while being refracted toward the rear of the lamp. Accordingly, it is possible to effectively prevent part of the light from the light-emitting diode 30 that is incident from the left end surface (first end surface) 20a of the light guide 20 from reaching the right end surface 20b (that is, the other end surface or the second end surface) of the light guide 20, either directly or after being internally reflected by the rear surface portion 20c or the front surface portion 20d, even though the light guide 20 is formed as a relatively short light guiding bar. This allows light emitted from the light-emitting diode 30 to be effectively utilized as light radiated from the lamp.

Thus, according to the shown embodiment, the vehicular lamp 10 including the light guide 20, can effectively utilize the light emitted from the light-emitting diode 30 as light radiated from the lamp even if the light guide 20 is relatively short.

In the shown embodiment, in addition, the second incident portion 20a2 is provided in the intermediate region of the left end surface 20a of the light guide 20 at a position forwardly adjacent to the first incident portion 20a1 so as to cause the light emitted from the light-emitting diode 30 to be incident into the light guide 20 while being refracted toward the front of the lamp. Accodingly, the light from the light-emitting diode 30 that is incident from the intermediate region of the left end surface 20a can be divided into a portion to be refracted forward and a portion to be refracted rearward. This can more effectively prevent light incident into the light guide 20 from the intermediate region of the left end surface 20a from directly reaching the right end surface 20b of the light guide 20.

In the shown embodiment, moreover, the third incident portion 20a3 is provided in the left end surface 20a of the light guide 20 in front of the second incident portion 20a2 so as to cause the light emitted from the light-emitting diode 30 to be incident into the light guide 20 while being refracted toward the rear of the lamp. Accordingly, most of the light that is incident from the third incident portion 20a3 can be totally reflected by the front surface portion 20d of the light guide 20 and thus be effectively utilized as light radiated from the lamp.

In the shown embodiment, furthermore, the fourth incident portion 20a4 is provided in the left end surface 20a of the light guide 20 at the rear of the first incident portion 20a1 so as to cause the light emitted from the light-emitting diode 30 to be incident into the light guide 20 while being refracted toward the front of the lamp. Accodingly, most of the light that is incident from the fourth incident portion 20a4 can be totally reflected by the rear surface portion 20c of the light guide 20 and effectively utilized as light radiated from the lamp.

In the shown embodiment, further, each of the first to fourth incident portions 20a1 to 20a4 is formed as a cylindrical lens that causes the light emitted from the light-emitting diode 30 to be incident as light that is generally parallel with a horizontal plane. Accodingly, light incident from the left end surface 20a can efficiently reach the plurality of reflective elements 20s provided in the rear surface portion 20c, allowing such light to be effectively utilized as light radiated from the lamp.

In the shown embodiment, in addition, the reflector 40 is disposed at the rear of (or behind) the light guide 20 to cause the light leaking from the light guide 20 to be re-incident into the light guide 20. Accodingly, even if light that is incident from the left end surface 20a of the light guide 20 leaks from the rear surface portion 20c of the light guide 20, such light can be effectively utilized as light radiated from the lamp.

In the shown embodiment, the internal reflection at the rear surface portion 20c of the light guide 20 is caused twice by the general portion of the rear surface portion 20c and the reflective element 20s that is rightwardly adjacent to the general portion. However, such an internal reflection can be made once by each of the reflective elements 20s.

In the above-described embodiment, in addition, the reflector 40 is provided as an independent member. However, a plurality of reflective elements that are similar to the plurality of reflective elements 40s provided on the reflector 40 can be provided in the front surface of the lamp body 12.

In the above-described embodiment, further, the vehicular lamp 10 is a tail lamp provided at the right rear end portion of a vehicle. However, the same configuration as that of the above-described embodiment can also be adopted in the case that the vehicular lamp 10 is a tail lamp provided at the left rear end portion of a vehicle or a lamp other than tail lamps.

Next, a modification of the above-described embodiment will be explained below.

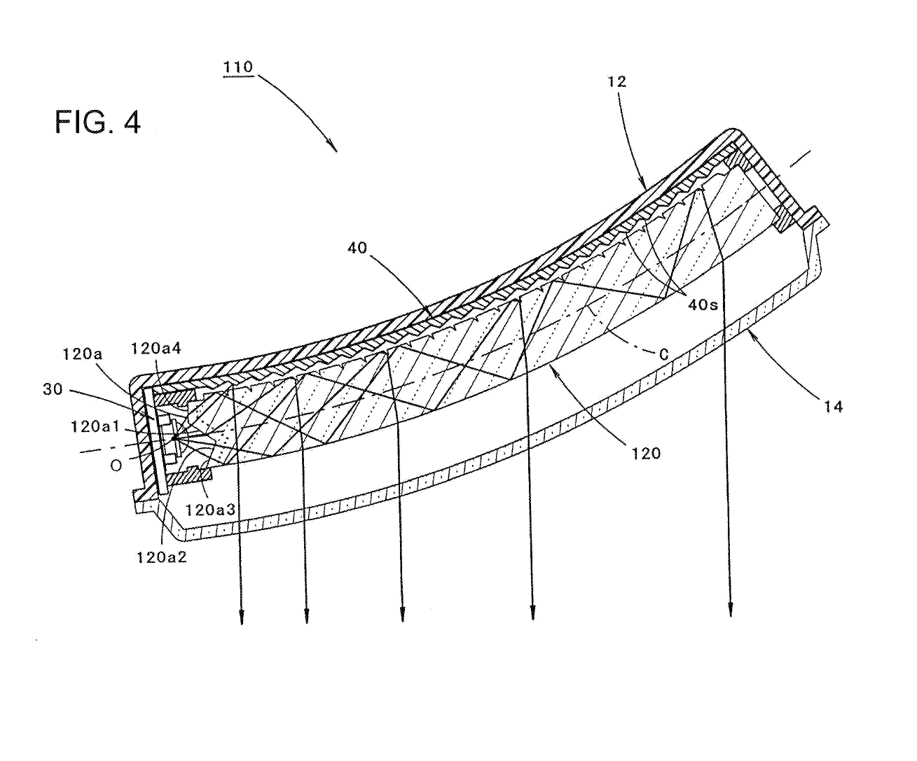

FIG. 4 is a view similar to FIG. 1, and it shows a vehicular lamp 110 according to a modification of the embodiment described above.

As seen from FIG. 4, though the configuration of the vehicular lamp 110 according to the modification of FIG. 4 is basically the same as that of the vehicular lamp 10 described above, the shape of the left end surface 120a of the light guide 120 is different from that of the left end surface 20a of the light guide 20 of the above-described embodiment.

More specifically, a first incident portion 120a1 is provided in an intermediate region, in the front-back direction, of the left end surface 120a of the light guide 120 so as to cause the light emitted from the light-emitting diode 30 to be incident into the light guide 120 while being refracted toward the rear of the lamp. A second incident portion 120a2 and a third incident portion 120a3 are continuously provided in front of the first incident portion 120a1 so as to cause, respectively, the light emitted from the light-emitting diode 30 to be incident into the light guide 120 while being refracted toward the rear of the lamp. In addition, a fourth incident portion 120a4 is provided in the rear of the first incident portion 120a1 so as to cause the light emitted from the light-emitting diode 30 to be incident into the light guide 120 while being refracted toward the front of the lamp.

The first incident portion 120a1 extends in a direction inclined rightward by about 50 to 60° with respect to the forward direction of the lamp as viewed from above. In addition, the second incident portion 120a2 and the third incident portion 120a3 provided in front of the second incident portion 120a2 extend in a direction inclined rightward by about 20 to 30° with respect to the forward direction of the lamp as viewed from above, and the fourth incident portion 120a4 extends in substantially the same direction as the forward direction of the lamp as viewed in plan.

The configuration according to the modification shown in FIG. 4, provides the same effects as those obtained by the embodiment shown in FIG. 1 through FIG. 3

The numerical values used in the embodiment and the modification above are merely exemplary, and it is a matter of course that different numerical values can be used appropriately.

1. A vehicular lamp comprising a light source and a light guide configured such that light emitted from the light source is incident into the light guide from one end surface thereof and thereafter internally reflected by a plurality of reflective elements provided in a rear surface portion of the light guide and then emitted out from a front surface portion of the light guide toward a front of the lamp, wherein:
said light guide extends along a first direction that intersects a front-back direction of the lamp, and
a first incident portion is provided in an intermediate region, in the front-back direction, of said one end surface of said light guide so as to cause the light emitted from said light source to be incident into said light guide while being refracted in a direction away from the first direction with respect to the front-back direction of the lamp.

2. The vehicular lamp according to claim 1, further comprising a second incident portion provided in said intermediate region, in the front-back direction, of said one end surface at a position adjacent to said first incident portion in the front-back direction so as to cause the light emitted from said light source to be incident into said light guide while being refracted in a direction opposite to the direction of the refraction caused by said first incident portion.

3. The vehicular lamp according to claim 1, wherein said first incident portion is provided as a cylindrical lens that causes the light emitted from said light source to be incident as light that is substantially parallel with a plane that includes the front-back direction of the lamp and the first direction.

4. The vehicular lamp according to claim 1, further comprising a third incident portion provided in front of said intermediate region of said one end surface so as to cause the light emitted from said light source to be incident into said light guide while being refracted toward the rear of the lamp.

5. The vehicular lamp according to claim 1, further comprising a fourth incident portion provided in the rear of said intermediate region of said one end surface so as to cause the light emitted from the light source to be incident into said light guide while being refracted toward the front of the lamp.

6. The vehicular lamp according to claim 1, further comprising a reflector disposed at the rear of said light guide so as to cause light leaking from said light guide to be re-incident into said light guide.

7. The vehicular lamp according to claim 2, wherein
said first incident portion is provided as a cylindrical lens that causes the light emitted from said light source to be incident as light that is substantially parallel with a plane that includes the front-back direction of the lamp and the first direction, and
said lamp further comprises
a third incident portion provided in front of said intermediate region of said one end surface so as to cause the light emitted from said light source to be incident into said light guide while being refracted toward the rear of the lamp,
a fourth incident portion provided in the rear of said intermediate region of said one end surface so as to cause the light emitted from the light source to be incident into said light guide while being refracted toward the front of the lamp, and
a reflector disposed at the rear of said light guide so as to cause light leaking from said light guide to be re-incident into said light guide.
